(19) United States
(12) Patent Application Publication
(10) Pub. No.: US 2007/0111698 A1
(43) Pub. Date: May 17, 2007

(54) METHOD AND APPARATUS FOR PROVIDING BEARER SELECTION AND TRANSMISSION PARAMETER CONFIGURATION

(76) Inventors: Manamohan Mysore, San Diego, CA (US); Jaimin Trivedi, San Diego, CA (US); Sarvesh Asthana, San Diego, CA (US)

Correspondence Address: DITTHAVONG MORI & STEINER, P.C., 918 Prince St., Alexandria, VA, 22314, US

(21) Appl. No.: 11/553,217

(22) Filed: Oct. 26, 2006

Related U.S. Application Data
(60) Provisional application No. 60/730,443, filed on Oct. 26, 2005.

(51) Int. Cl. H04B 1/16

(52) U.S. Cl. 455/338; 370/437; 370/328; 370/252; 370/395.1

(57) ABSTRACT

An approach is disclosed for providing bearer selection and transmission parameter configuration between a wireless terminal and a computing device. A request message is received from the computing device that is configured to execute a plurality of applications, wherein the request message specifies selection of a bearer channel and quality of service (QoS) requirement to support one of the applications. In response to the received request message, the bearer channel is configured with the QoS requirement, wherein the configured bearer channel is established for the one application.

### RELATED APPLICATIONS

This application claims the benefit of the earlier filing date under 35 U.S.C. §119(e) of U.S. Provisional Application Ser. No. 60/730,443 filed Oct. 26, 2005, entitled “Method and Apparatus for Providing Bearer Selection and Transmission Parameter Configuration”; the entirety of which is incorporated by reference.

### FIELD OF THE INVENTION

Embodiments of the invention relate to communications, and more particularly, to supporting quality of service (QoS) requirements for multiple applications within a radio network.

### BACKGROUND

Radio communication systems, such as cellular systems (e.g., spread spectrum systems (such as Code Division Multiple Access (CDMA) networks), or Time Division Multiple Access (TDMA) networks) and broadcast systems (e.g., Digital Video Broadcast (DVB)), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One key area of effort involves supporting a multitude of applications over high speed data connections and in accordance with quality of service (QoS) requirements. Unfortunately, this function is not effectively supported by current protocols.

Therefore, there is a need for an approach to identify transmission requirements of applications resident within a computing device (e.g., terminal equipment).

### SOME EXEMPLARY EMBODIMENTS

These and other needs are addressed by the invention, in which an approach is presented for accounting for the types of applications as to effectively accommodate for transmission requirements.

According to one aspect of an embodiment of the invention, a method comprises receiving a request message from a computing device that is configured to execute a plurality of applications, wherein the request message specifies selection of a bearer channel and quality of service (QoS) requirement to support one of the applications. The method also comprises configuring the bearer channel with the QoS requirement in response to the received request message, wherein the configured bearer channel is established for the one application.

According to another aspect of an embodiment of the invention, an apparatus comprises a processor configured to receive a request message from a computing device that is configured to execute a plurality of applications, wherein the request message specifies selection of a bearer channel and quality of service (QoS) requirement to support one of the applications. The processor is further configured to, in response to the received request message, configure the bearer channel with the QoS requirement, wherein the configured bearer channel is established for the one application.

According to another aspect of an embodiment of the invention, a method comprises receiving a configuration request message from a mobile terminal that is coupled to a computing device, wherein the computing device is configured to execute a plurality of applications and to specify, to the mobile terminal, selection of a bearer channel and quality of service (QoS) requirement to support one of the applications. The method further comprises generating an acknowledgement message, in response to the configuration request message, to acknowledge the selection of the bearer channel and the QoS requirement.

According to yet another aspect of an embodiment of the invention, an apparatus comprises a processor configured to receive a configuration request message from a mobile terminal that is coupled to a computing device, wherein the computing device is configured to execute a plurality of applications and to specify, to the mobile terminal, selection of a bearer channel and quality of service (QoS) requirement to support one of the applications. The processor is further configured to generate an acknowledgement message, in response to the configuration request message, to acknowledge the selection of the bearer channel and the QoS requirement.

Still other aspects, features, and advantages of the embodiments of the invention are readily apparent from the following detailed description, simply by illustrating a number of particular embodiments and implementations, including the best mode contemplated for carrying out the embodiments of the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings and in which like reference numerals refer to similar elements and in which:

FIGS. 1A and 1B are, respectively, a diagram of an exemplary network interface reference model supporting data services between a terminal equipment (TE) and a mobile termination (MT), and a flowchart of a process for conveying control and/or configuration parameters, in accordance with various embodiments of the invention;

FIG. 2 is a diagram of a process for establishing a data connection using Point-to-Point Protocol (PPP) link between a terminal equipment and a mobile termination, according to an embodiment of the invention;

FIG. 3 is a diagram of exemplary protocol formats for supporting exchange of configuration information between a terminal equipment and a mobile termination, according to various embodiments of the invention;

FIG. 4 is a diagram of a process for routing control data between a terminal equipment and a mobile termination, according to various embodiments of the invention;

FIG. 5 is a diagram of hardware that can be used to implement an embodiment of the invention;

FIGS. 6A and 6B are diagrams of different cellular mobile phone systems capable of supporting various embodiments of the invention;

FIG. 7 is a diagram of exemplary components of a mobile station capable of operating in the systems of FIGS. 10A and 10B, according to an embodiment of the invention; and

FIG. 8 is a diagram of an enterprise network capable of supporting the processes described herein, according to an embodiment of the invention.

### DESCRIPTION OF THE PREFERRED EMBODIMENT

An apparatus, method, and software for providing control and/or configuration information in support of providing transmission parameters (e.g., QoS parameters) between a computing device (e.g., terminal equipment) and a wireless device (e.g., mobile termination) are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a spread spectrum system and a digital video broadcast system, it is recognized by one of ordinary skill in the art that the embodiments of the inventions have applicability to any type of radio communication system as well as wired networks. Additionally, it is contemplated that the protocols and processes described herein can be performed not only by mobile and/or wireless devices, but by any fixed (or non-mobile) communication device (e.g., desktop computer, network appliance, etc.) or network element or node.

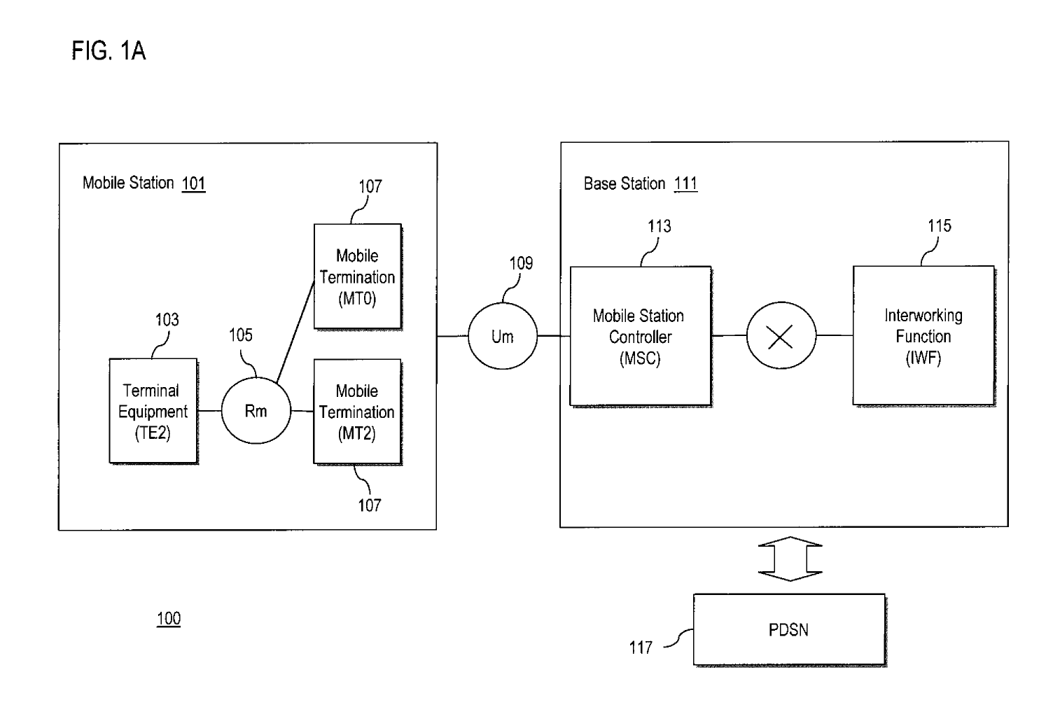

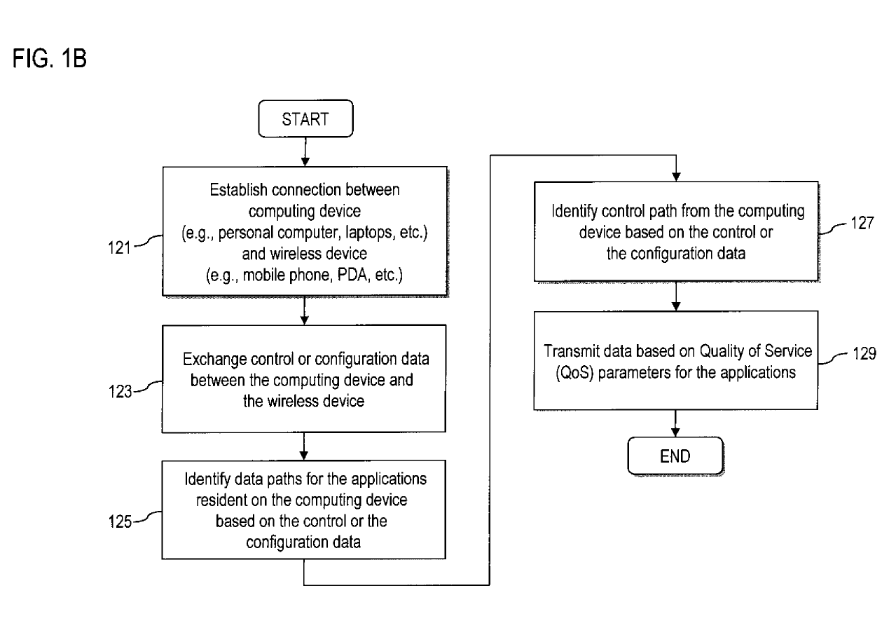

FIG. 1A shows a diagram of an exemplary network interface reference model supporting data services between a terminal equipment (TE) and a mobile termination (MT), in accordance with various embodiments of the invention. With advanced wireless technologies (e.g., cellular, broadband etc), high speed data connections with quality of service (QoS) can be readily supported. For instance, handheld devices (e.g., PDAs (Personal Digital Assistance)), such as mobiles phones that utilize these wireless technologies, can be used as a modem to connect to, for example, a personal computer or a laptop. Use of the mobile phones as a modem to connect to the personal computer or the laptop for connecting to the Internet has become prevalent and is widely adopted by the industry as well as by the end users. This model of Internet access has been fueled by technological advances, such as 1× EVDO (Evolution Data Only) mobiles and PCMCIA (Personal Computer Memory Card International Association) cards.

By way of illustration, the communication system 100 of FIG. 1A is explained in the framework of the 3GPP2 (Third Generation Partnership Project 2) reference model. The system 100 utilizes a mobile station 101 that includes a terminal equipment (TE) 103 in communication, via a Rm interface 105, with one or more mobile terminations 107. According to an exemplary embodiment, the mobile terminations 107 include handheld devices, and the terminal equipment 103 comprises a computing device (e.g., laptops, desktop computers, workstations, etc.). To allow applications residing on the computing device 103 to take advantage of the enhanced functionalities of cellular services, the system 100 provide a mechanism for the TE2 103 to specify quality of service (QoS) parameters to MT2 107. However, conventionally, no such mechanism exists; for instance, the 3GPP2 TSG C.S0017-003-A standard, which governs the interaction between the TE2 and the MT2, does not specify such a mechanism.

Although the exemplary embodiments described herein employ the terms “MT” and “TE,” it is contemplated that the invention has applicability to any wireless device and computing devices. To enable the use of a mobile handset as a modem, 3GPP2 defines an interface between the personal computer (termed “TE2”) and the mobile handset (termed “MT2”) referred to as the Rm interface 105. This interface allows the TE2 103 to issue access terminal (AT) modem commands to the MT2 107. These AT commands and the Rm interface 105 are detailed in 3GPP2 TSG C.S0017-003-A standard (which is incorporated herein by reference in its entirety).

The use of conventional AT commands is not well-suited for dynamic configuration and control. First, use of such AT commands has the limitation of not able to support signaling and application data in the same time. For instance, after the call is established, to send additional AT command, the MT2 has to be placed in online command status. During this state, application data cannot be sent until the MT2 is placed back to the online state.

Furthermore, AT commands cannot be issued concurrently with data. Online AT commands may be issued, but requires having to put data transfer temporarily on hold. AT commands and responses are not structured enough to provide extensibility. New protocol primitives and structure would need to be constructed, which entails the introduction of extra code and complexity. Moreover, there are situations where the AT commands may not even be invoked, for example if a PCMCIA or USB (Universal Serial Bus) EV-DO device is used, it may be advantageous to depart from the limiting AT command framework.

With the advent of, for example, multi-mode phones supporting multiple radio technologies, it is recognized that the Rm interface 105 needs to permit the TE2 103 to indicate its intent to use a certain air-link bearer to the MT2 107. However, this is not possible with the traditional Rm Interface.

Conventionally, an Rm interface is a serial connection that does not support intra user QoS. In other words, such conventional Rm interface does not provide a mechanism for the MT2 to distinguish different application traffic from the TE2. The Rm interface supports a relay model and a network model; both models treat MT2 as a data pipe, except the network model allows MT2 to provide mobile IP support for TE2. The TE2 can configure the MT2 through a series of modem or AT commands.

Within the higher data rate and the QoS supported environment, when the MT2 107 is connected to the TE2 103, multiple applications can be run in the TE2 103 (such as Voice over Internet Protocol (VoIP), data transfers, web browser, text messaging, etc.) in parallel. It is recognized that the MT2 107 should be made aware of the type of applications that are running on the TE 103 as well as any requirements of the particular applications (e.g., QoS parameters).

A communication system (which implements the 1× EVDO Rev A architecture, for example) can provide QoS support for data flows on the air-link, thereby enabling/enhancing real-time applications such as VoIP. It is recognized that applications running on the MT2 107 can exploit this QoS support because the same device that requests the air-link QoS also runs these applications. Such applications running on the TE2 103 may also benefit from the QoS support offered by the air link.

However, with the conventional Rm interface, it is not possible for a TE2 to configure QoS support on the airlink via the MT2. Also, it is not possible for the MT2 to apply QoS policies to ensure that data flows originating from the TE2 receive the desired QoS over the airlink. This system 100, according to various embodiments, provides mechanisms for configuration of bearer and QoS profiles/policies on the MT2 107 according to TE2 application requirements.

The communication system 100, according to one aspect, provides a mechanism to create a data session or channel between TE2 103 and MT2 107 to exchange data (control or configuration data) between them. Under this arrangement, the MT2 107 can be made aware of all the required parameters about the applications (e.g., transmission parameters) that reside within TE2 103.

As shown, the mobile station 101 communicates over an Um interface 109 with a base station 111. The base station 111 includes a mobile station controller 113 (MSC) and an interworking function (IWF) 115. The IWF 115 provides the necessary functions for the terminal equipment 103 connected to the mobile termination 107 to inter-work with terminal equipment connected to, for example, PSTN (Public Switched Telephone Network) (not shown). Further, the base station 111 communicates with a Packet Data Serving Node (PDSN) 117, which provides connectivity to data networks, such as the global Internet.

An enhanced Rm interface (denoted as “Rm+”) has been considered to address the drawbacks associated with the conventional Rm interface; the Rm+ interface is described in 3GPP2.C13-20050926-003, which is incorporated herein by reference in its entirety). This approach utilizes an IP connection between TE2 and MT2 to exchange configuration message between TE2 and MT2.

However, this enhanced Rm interface approach does not address the following issues: (1) how the IP connection is established; and (2) the routing of configuration data and application data. With respect to the first issue, it is not specified how the TE2 103 obtains the IP address. This is an essential step for further configuration. Moreover, this step is not necessarily coupled with the PPP protocol, as other protocol such as DHCP (Dynamic Host Configuration Protocol) can be used.

As for the second issue, after the configuration between TE2 and MT2 is completed, application data can be exchanged. However, potential additional configuration between TE2 and MT2 may be needed. It is important to route these two types of data since the configuration data is terminated in MT2, and the application data should be forwarded to the cellular networks. The proposed approach fails to describe how routing of these data is accomplished.

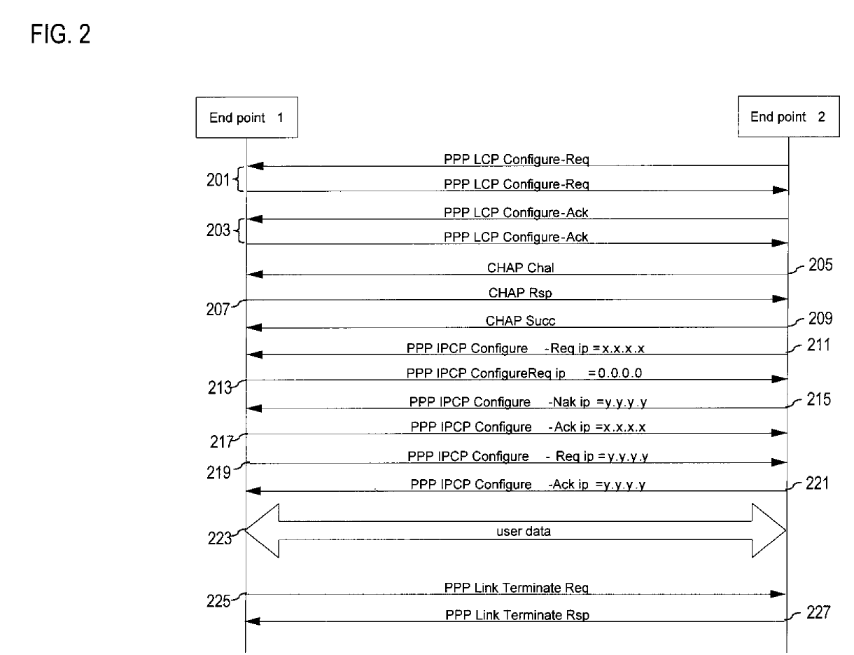

The system 100, according to various embodiments, provides bearer selection and QoS configuration at the link/host configuration level to overcome the drawbacks of the conventional systems. This process is more fully described with respect to FIGS. 2-4.

FIG. 1B is a flowchart of a process for conveying control and/or configuration parameters, in accordance with various embodiments of the invention. In step 121, a connection is established between computing device (e.g., personal computer, laptops, etc.) and wireless device (e.g., mobile phone, PDA, etc.). In the system 100, the computer device is represented by the terminal equipment 103, and the wireless device is represented by the mobile termination 107. The computing device 103 and the wireless device 107, per step 123, exchange control or configuration data. In step 125, data paths for the applications are identified based on the control or the configuration data; these applications reside in the computing device. Next, the wireless device 107 identifies the control path from the computing device based on the control or the configuration data, as in step 127. The computing device, per step 129, transmits data based on Quality of Service (QoS) parameters for the applications.

In an exemplary embodiment, the extended QoS related options include the following information: (1) packet filters or tags to identify flow; and (2) QoS or flow parameters requested for the flow. These extended options provide a negotiation channel between the TE2 103 and MT2 107, and hence, can either be generated by the TE2 103 and consumed by the MT2 107 or vice versa. Also the negotiation of packet filters and QoS parameters can take place at anytime during the data flow. Thus, this approach provides high flexibility for negotiating all of the above configuration parameters; and moreover, it does so at the link level, avoiding any complexities at higher levels in the protocol stack.

According to various embodiments of the invention, it is assumed that there exists a link/host configuration phase in which there is an opportunity to negotiate various parameters with the network (not shown). The link/host configuration subsystem/protocol, such as LCP (Link Control Protocol) in PPP (Point-to-Point Protocol) (or via Vendor Specific Packet extensions to PPP as in Internet Engineering Task Force (IETF) Request For Comment (RFC) 2153, which is incorporated herein by reference in its entirety), or DHCP (Dynamic Host Configuration Protocol), or AltPPP (Alternate Point-to-Point Protocol), is enhanced with options (or sub blocks) so as to allow the negotiation of bearer and QoS configuration parameters. Such a link/host configuration subsystem is designed at the outset with “negotiation” capability. This invention, according to various embodiments, proposes the reuse of negotiation primitives already existing in this subsystem in order to achieve bearer/QoS configuration on the Rm interface 105. For the purposes of illustration, this approach is explained in the context of PPP. However, this approach is applicable on the Rm layer (or equivalent), wherever a point-to-point link/host configuration subsystem exists.

FIG. 2 shows the phases typically involved in PPP link establishment, according to an embodiment of the invention. The approach, according to one embodiment of the invention, involves the use of vendor specific and/or standard extensions to PPP; however, other equivalent protocols can be utilized (e.g., other PPP variants, such as AltPPP, or over DHCP).

As seen in FIG. 2, the endpoint 1 and endpoint 2 could be either TE2 103 or MT2 107, respectively. In step 201, each endpoint sends a configuration request message, PPP LCP Configure-Req, to the other endpoint over the Rm interface 105. Next, acknowledgment messages are exchanged, e.g., PPP LCP Configure-Ack (as in step 203), in response to receipt of the respective PPP LCP Configure-Req messages.

In step 205, endpoint 2 sends CHAP Challenge message (denoted “CHAP Chal”) to endpoint 1. In response to the CHAP Chal, endpoint 1 sends a CHAP response message (“CHAP Rsp”) to endpoint 2, per step 207. Thereafter, in step 209, CHAP session is successfully established, as indicated by the CHAP successful message transmitted by endpoint 2 to endpoint 1. In step 211, endpoint 2 sends a PPP IPCP Configure-Req (e.g., ip=x.x.x.x) message to endpoint 1. In turn, per step 213, endpoint 1 sends PPP IPCP Configure-Req (e.g., ip=0.0.0.0). Subsequently, endpoint 2 sends PPP IPCP Configure-Nak (e.g., ip=y.y.y.y), per step 215.

In step 217, endpoint 1 sends PPP IPCP Configure-Ack (e.g., ip=x.x.x.x) to endpoint 2. Upon receipt of PPP IPCP Configure-Req (e.g., ip=y.y.y.y), per step 219, endpoint 2 sends, per step 221, PPP IPCP Configure-Ack (e.g., ip=y.y.y.y) to endpoint 1.

Per step 223, the PPP link is established, in which user data is exchanged between endpoint 1 and endpoint 2. The PPP link can be terminated through a request and response message exchange (e.g., PPP Link Terminate Request message and PPP link Terminate Response), per steps 225 and 227. In this scenario, the termination is initiated by endpoint 1.

According to one embodiment, PPP utilizes LCP to configure link parameters. LCP defines methods such as the Configure-Request, Configure-Ack to enable negotiation, which can utilize several “LCP Options” formats, as described below.

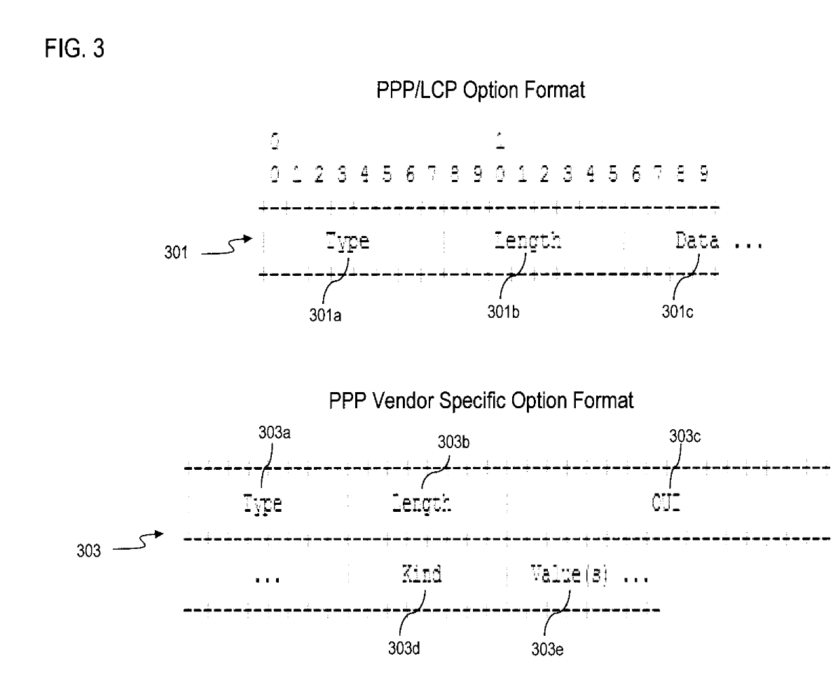

FIG. 3 is a diagram of exemplary protocol formats for supporting exchange of configuration information between a terminal equipment and a mobile termination, according to various embodiment of the invention. The PPP/LCP option format 301 includes a type field 301a, a length field 301b, and a data field 301c. In an exemplary embodiment, the Type field 301a is one octet, and indicates the type of configuration option, and can be specified according to Table 1:

TABLE 1

| Type Field | Configuration Option |
|---|---|
| 0 | RESERVED |
| 1 | Maximum-Receive-Unit |
| 3 | Authentication-Protocol |
| 4 | Quality-Protocol |
| 5 | Magic-Number |
| 7 | Protocol-Field-Compression |
| 8 | Address-and-Control-Field-Compression |

The above Table 1 defining the LCP option type is specified, for example, in STD 2, RFC 1340, USC/Information Sciences Institute, entitled “Assigned Numbers,” Reynolds, J., and Postel, J., July 1992; which is incorporated herein by reference in its entirety.

In this example, the Length field 303 is one octet, and indicates the length of this configuration option. If a negotiable Configuration Option is received in a Configure-Request, but with an invalid or unrecognized Length, a Configure-Nak can be transmitted which includes the desired configuration option. The Data field 301c contains the data payload.

Alternatively, a vendor-specific option format 303 can be employed. This format 303 includes a Type field 303a, a Length field 303b, an OUI (Organization Unique Identifier) field 303c, a Kind field 303d, and a Value(s) field 303e; these fields are described in Table 2:

TABLE 2

| Format | Values |
|---|---|
| Type | 0 |
| Length | >=6, when the Length is six, no Value(s) is |
| | present |
| OUI | Three octets. Vendor's organization unique |
| | identifier. The bits within the octets are in |
| | canonical order, and the most significant octet is |
| | transmitted first |
| Kind | One octet. Indicates a sub-type for the OUI. |
| | There is no standardization for this field. Each |
| | OUI implements its own values. The Kind field |
| | may be extended by the vendor to include zero or |
| | more octets of the Value(s) field. |
| Value(s) | Zero or more octets. |

In an exemplary embodiment, to support bearer and QoS configuration, the following LCP options may be defined, as enumerated in Table 3:

TABLE 3

| Option | | |
|---|---|---|
| Type | Option Name | Description |
| 12 | Bearer Selection Request | Selects bearer (EVDO, |
| | | WLAN, etc.) |
| 13 | Bearer Selection Response | Acknowledges bearer selection |
| 14 | QoS Configuration Request | Configures QoS options |
| 15 | QoS Configuration Response | Acknowledges QoS Options |
| 16 & 17 | QoS Reserved | Reserved for now |

It should be noted that LCP configure-request approach may be used to specify certain QoS and Bearer related parameters in the beginning of the PPP session. However, if LCP configure-request mechanism is used when data is flowing between the PPP endpoints, it can cause the entire PPP session to be renegotiated.

In another embodiment of the invention, Vendor Specific methods (as specified in RFC 2153 which is incorporated herein by reference in its entirety) “QoS Configure Request” and “QoS Configure Response” may be utilized.

It is recognized that the specific format of these options can be any general and convenient format that achieves the necessary Bearer/QoS operations.

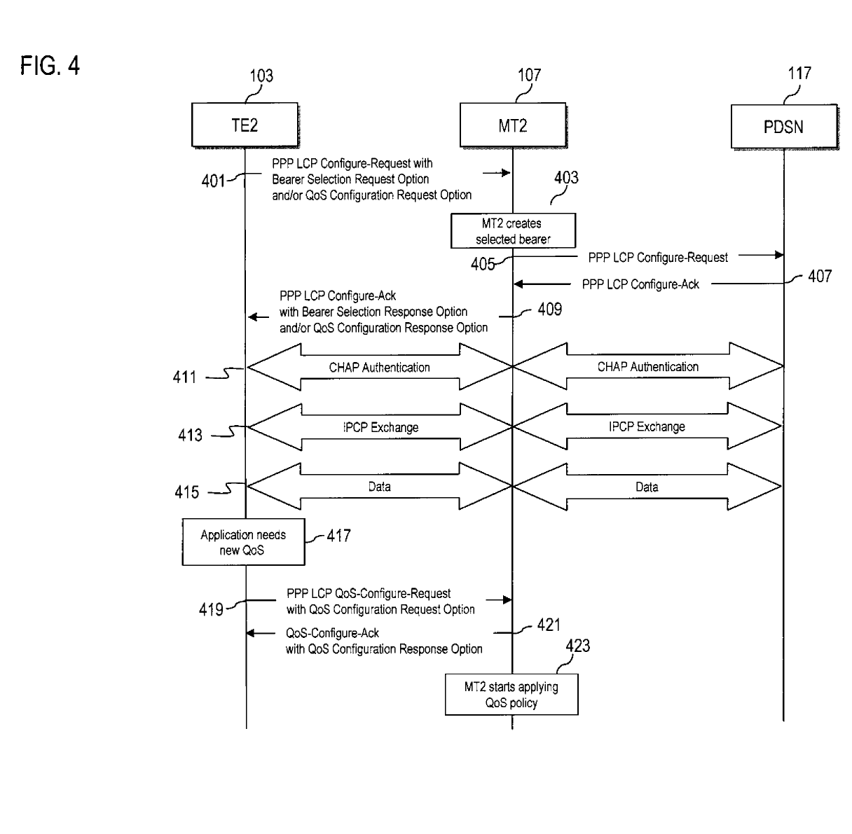

FIG. 4 is a diagram of a process for routing control data between a terminal equipment and a mobile termination, according to various embodiments of the invention. Under this scenario, TE2 103 sends, as in step 401, a configuration request message (e.g., LCP Configure-Request) with a Bearer Selection Request option containing the TE2 preferred bearer (such as EV-DO). TE2 103 may also include QoS Config Request option (or alternately, Vendor Specific option) blocks to specify that QoS parameters applicable at the time of bearer creation. The MT2 107 then selects and creates the requested bearer (if possible/allowed), per step 403. After bearer creation, the MT2 107 forwards the PPP to the PDSN 401. In this case, the network model is assumed.

In step 403, MT2 107 sends a PPP LCP Configure-Request to the network—i.e., PDSN 117. Next, the PDSN 117 acknowledges the request with a PPP LCP Configure-Ack back to MT 2 107 (step 407). Subsequently, in step 409, MT2 107 sends an acknowledgement message, LCP Configure-Ack, with the Bearer Selection Response option (or alternately, Vendor Specific option), in response to the configuration request message. This message indicates whether the particular bearer is available, and also can include the response to other options included in the Configure-Request. Thereafter, in step 411, CHAP Authentication is performed, along with the IPCP Exchange (step 413). Consequently, a data path is established, per step 415.

At this point, the TE2 103 determines that a new quality of service is required to support the application (step 417). Accordingly, in step 419, the TE2 103 generates a PPP LCP QoS-Configure Request message to specify the new set of desired QoS parameters. Specifically, when the application of TE2 103 needs a new QoS, the TE2 103, uses the QoS Configure-Request extended method (or alternately, Vendor Specific method) with the QoS Config Req option (or alternately, Vendor Specific option) to set QoS parameters in the MT2 107. These options may contain the following information: (1) packet filters or tags to identify flow, (2) QoS or flow parameters requested for the flow, and (3) lifetime and other miscellaneous parameters.

In step 421, MT2 107 sends a QoS Configure-Ack extended method (or alternately, Vendor Specific method) with the QoS Config Resp option (or alternately, Vendor Specific option) indicating whether to accept or reject those QoS parameters. MT2 107 configures data flows according to the QoS parameters specified by TE2 103, and starts applying that QoS for the relevant flow (step 423).

It is noted that the above flow is valid for both network and relay model calls. Also, in an exemplary embodiment, bearer and QoS configuration using the QoS Configure-Request and QoS Configure-Ack methods (or alternately, Vendor Specific methods) can be initiated by either end at any time during the data session.

It is recognized that there may be a need for asynchronous event notification from the MT2 107 to TE2 103—for example if a certain QoS flow is no longer available. Under this circumstance, the MT2 107 can send a QoS Configure-Request extended method (or alternately, Vendor Specific method) to the TE2 103 with a QoS Configure Request option (or alternately, Vendor Specific option) communicating either this change or the current QoS allocation status. It is noted that LCP packets are not used for bearer or QoS configuration during data transfer.

The above arrangement effectively addresses the link/host configuration issue at the link/host configuration level, utilizing existing link/host configuration protocols and primitives (such as PPP, AltPPP or DHCP). As noted, such approach is usable with both network and relay model calls. Although the above arrangement is described with respect to the LCP protocol, it is recognized that if a different link layer is used, other equivalent mechanisms can be utilized.

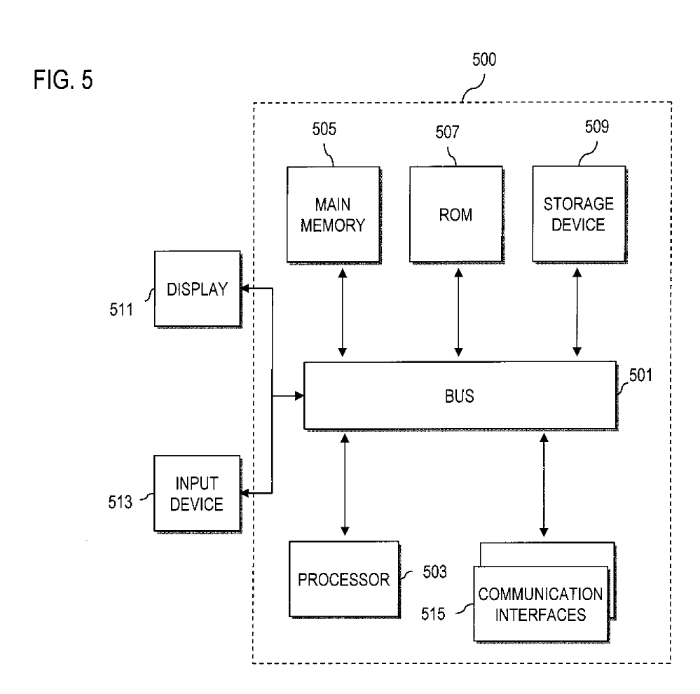

One of ordinary skill in the art would recognize that the above key processes may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 5.

FIG. 5 illustrates exemplary hardware upon which various embodiments of the invention can be implemented. A computing system 500 includes a bus 501 or other communication mechanism for communicating information and a processor 503 coupled to the bus 501 for processing information. The computing system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computing system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computing system 500 may be coupled via the bus 501 to a display 511, such as a liquid crystal display, or active matrix display, for displaying information to a user. An input device 513, such as a keyboard including alphanumeric and other keys, may be coupled to the bus 501 for communicating information and command selections to the processor 503. The input device 513 can include a cursor control, such as a mouse, a trackball, or cursor direction keys, for communicating direction information and command selections to the processor 503 and for controlling cursor movement on the display 511.

According to various embodiments of the invention, the processes described herein can be provided by the computing system 500 in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 500 also includes at least one communication interface 515 coupled to bus 501. The communication interface 515 provides a two-way data communication coupling to a network link (not shown). The communication interface 515 sends and receives electrical, electromagnetic, or optical signals that carry digital data streams representing various types of information. Further, the communication interface 515 can include peripheral interface devices, such as a Universal Serial Bus (USB) interface, a PCMCIA (Personal Computer Memory Card International Association) interface, etc.

The processor 503 may execute the transmitted code while being received and/or store the code in the storage device 509, or other non-volatile storage for later execution. In this manner, the computing system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

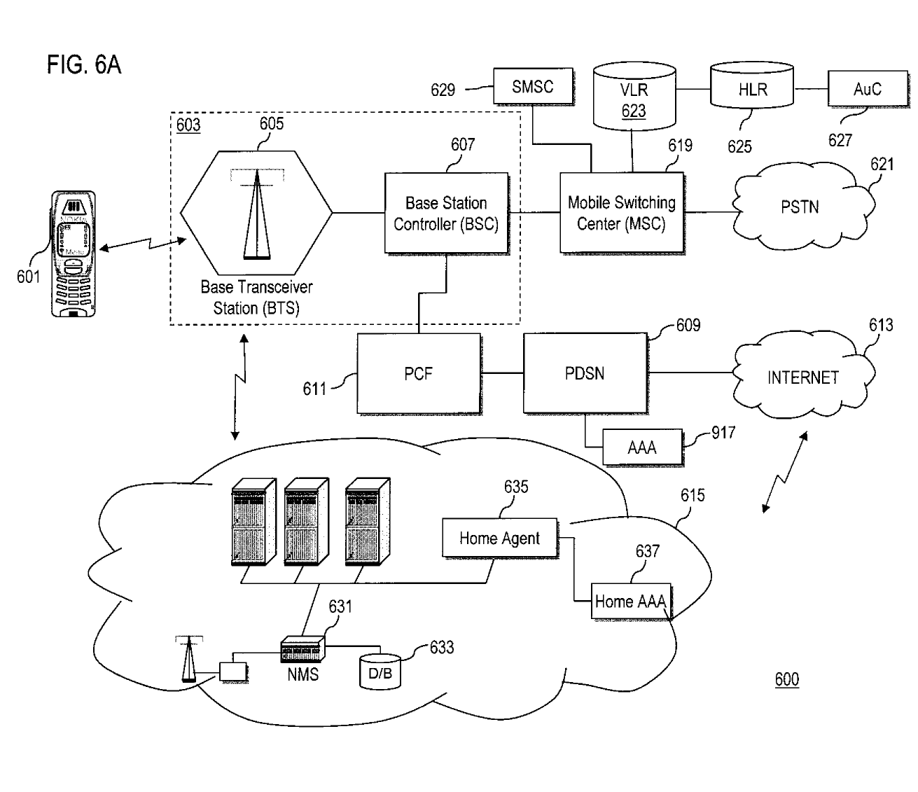

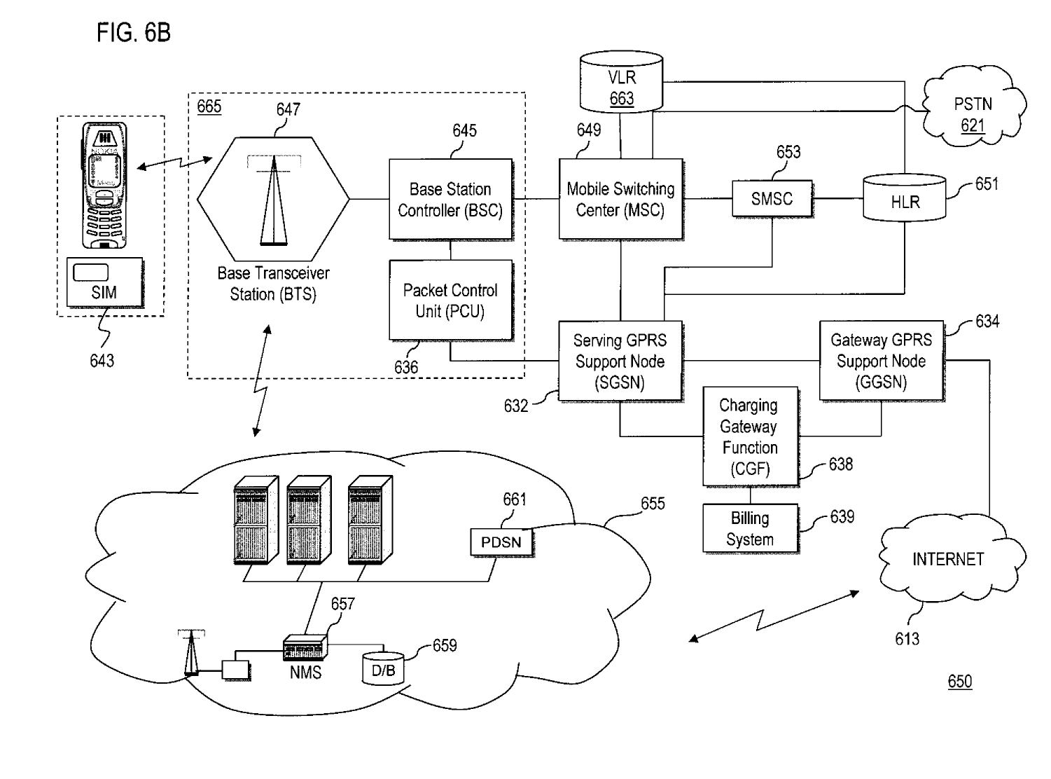

FIGS. 6A and 6B are diagrams of different cellular mobile phone systems capable of supporting various embodiments of the invention. FIGS. 6A and 6B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 600 includes mobile stations 601 (e.g., handsets, terminals, stations, units, devices, or any type of interface to the user (such as “wearable” circuitry, etc.)) in communication with a Base Station Subsystem (BSS) 603. According to one embodiment of the invention, the radio network supports Third Generation (3G) services as defined by the International Telecommunications Union (ITU) for International Mobile Telecommunications 2000 (IMT-2000).

In this example, the BSS 603 includes a Base Transceiver Station (BTS) 605 and Base Station Controller (BSC) 607. Although a single BTS is shown, it is recognized that multiple BTSs are typically connected to the BSC through, for example, point-to-point links. Each BSS 603 is linked to a Packet Data Serving Node (PDSN) 609 through a transmission control entity, or a Packet Control Function (PCF) 611. Since the PDSN 609 serves as a gateway to external networks, e.g., the Internet 613 or other private consumer networks 615, the PDSN 609 can include an Access, Authorization and Accounting system (AAA) 617 to securely determine the identity and privileges of a user and to track each user's activities. The network 615 comprises a Network Management System (NMS) 631 linked to one or more databases 633 that are accessed through a Home Agent (HA) 635 secured by a Home AAA 637.

Although a single BSS 603 is shown, it is recognized that multiple BSSs 603 are typically connected to a Mobile Switching Center (MSC) 619. The MSC 619 provides connectivity to a circuit-switched telephone network, such as the Public Switched Telephone Network (PSTN) 621. Similarly, it is also recognized that the MSC 619 may be connected to other MSCs 619 on the same network 600 and/or to other radio networks. The MSC 619 is generally collocated with a Visitor Location Register (VLR) 623 database that holds temporary information about active subscribers to that MSC 619. The data within the VLR 623 database is to a large extent a copy of the Home Location Register (HLR) 625 database, which stores detailed subscriber service subscription information. In some implementations, the HLR 625 and VLR 623 are the same physical database; however, the HLR 625 can be located at a remote location accessed through, for example, a Signaling System Number 7 (SS7) network. An Authentication Center (AuC) 627 containing subscriber-specific authentication data, such as a secret authentication key, is associated with the HLR 625 for authenticating users. Furthermore, the MSC 619 is connected to a Short Message Service Center (SMSC) 629 that stores and forwards short messages to and from the radio network 900.

During typical operation of the cellular telephone system, BTSs 605 receive and demodulate sets of reverse-link signals from sets of mobile units 601 conducting telephone calls or other communications. Each reverse-link signal received by a given BTS 605 is processed within that station. The resulting data is forwarded to the BSC 607. The BSC 607 provides call resource allocation and mobility management functionality including the orchestration of soft handoffs between BTSs 605. The BSC 607 also routes the received data to the MSC 619, which in turn provides additional routing and/or switching for interface with the PSTN 621. The MSC 619 is also responsible for call setup, call termination, management of inter-MSC handover and supplementary services, and collecting, charging and accounting information. Similarly, the radio network 600 sends forward-link messages. The PSTN 621 interfaces with the MSC 619. The MSC 619 additionally interfaces with the BSC 607, which in turn communicates with the BTSs 605, which modulate and transmit sets of forward-link signals to the sets of mobile units 601.

As shown in FIG. 6B, the two key elements of the General Packet Radio Service (GPRS) infrastructure 650 are the Serving GPRS Supporting Node (SGSN) 632 and the Gateway GPRS Support Node (GGSN) 634. In addition, the GPRS infrastructure includes a Packet Control Unit PCU 636 and a Charging Gateway Function (CGF) 638 linked to a Billing System 639. A GPRS the Mobile Station (MS) 641 employs a Subscriber Identity Module (SIM) 643.

The PCU 636 is a logical network element responsible for GPRS-related functions such as air interface access control, packet scheduling on the air interface, and packet assembly and re-assembly. Generally the PCU 636 is physically integrated with the BSC 645; however, it can be collocated with a BTS 647 or a SGSN 632. The SGSN 632 provides equivalent functions as the MSC 649 including mobility management, security, and access control functions but in the packet-switched domain. Furthermore, the SGSN 632 has connectivity with the PCU 636 through, for example, a Fame Relay-based interface using the BSS GPRS protocol (BSSGP). Although only one SGSN is shown, it is recognized that that multiple SGSNs 631 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 645, any given BSC 645 generally interfaces with one SGSN 632. Also, the SGSN 632 is optionally connected with the HLR 651 through an SS7-based interface using GPRS enhanced Mobile Application Part (MAP) or with the MSC 649 through an SS7-based interface using Signaling Connection Control Part (SCCP). The SGSN/HLR interface allows the SGSN 632 to provide location updates to the HLR 651 and to retrieve GPRS-related subscription information within the SGSN service area. The SGSN/MSC interface enables coordination between circuit-switched services and packet data services such as paging a subscriber for a voice call. Finally, the SGSN 632 interfaces with a SMSC 653 to enable short messaging functionality over the network 650.

The GGSN 634 is the gateway to external packet data networks, such as the Internet 613 or other private customer networks 655. The network 655 comprises a Network Management System (NMS) 657 linked to one or more databases 659 accessed through a PDSN 661. The GGSN 634 assigns Internet Protocol (IP) addresses and can also authenticate users acting as a Remote Authentication Dial-In User Service host. Firewalls located at the GGSN 634 also perform a firewall fiction to restrict unauthorized traffic. Although only one GGSN 634 is shown, it is recognized that a given SGSN 632 may interface with one or more GGSNs 633 to allow user data to be tunneled between the two entities as well as to and from the network 650. When external data networks initialize sessions over the GPRS network 650, the GGSN 634 queries the HLR 651 for the SGSN 632 currently serving a MS 641.

The BTS 647 and BSC 645 manage the radio interface, including controlling which Mobile Station (MS) 641 has access to the radio channel at what time. These elements essentially relay messages between the MS 641 and SGSN 632. The SGSN 632 manages communications with an MS 641, sending and receiving data and keeping track of its location. The SGSN 632 also registers the MS 641, authenticates the MS 641, and encrypts data sent to the MS 641.

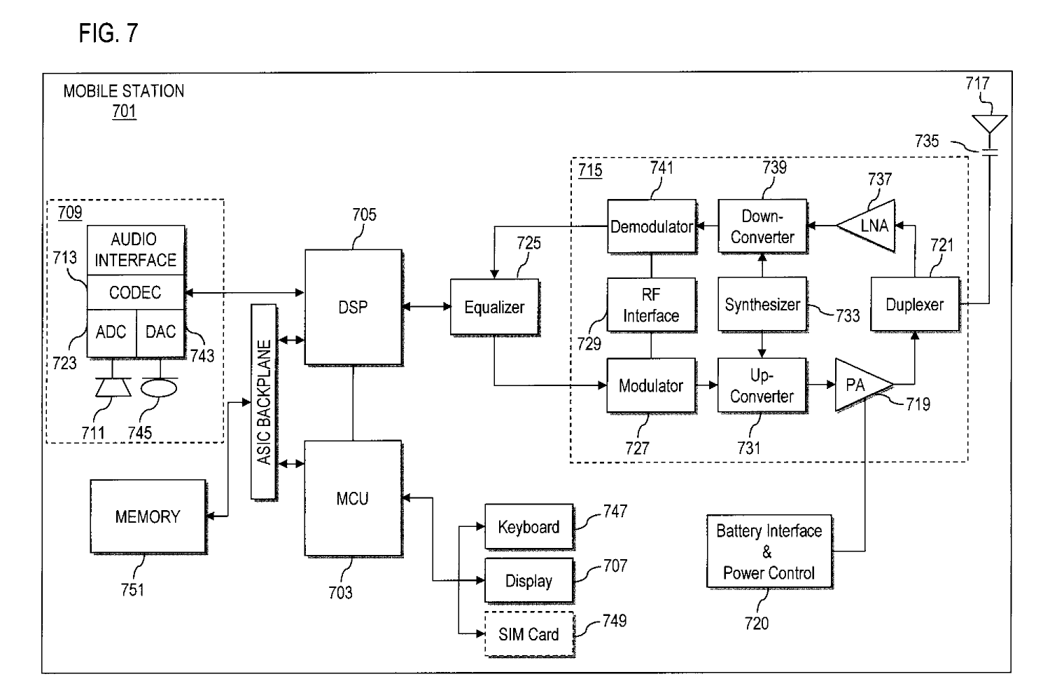

FIG. 7 is a diagram of exemplary components of a mobile station (e.g., handset) capable of operating in the systems of FIGS. 6A and 6B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system (e.g., systems of FIG. 6A or 6B), via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile station 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The MCU 703 delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile station 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile station 701 on a radio network. The card 749 also contains a memory for storing a personal telephone number registry, text messages, and user specific mobile station settings.

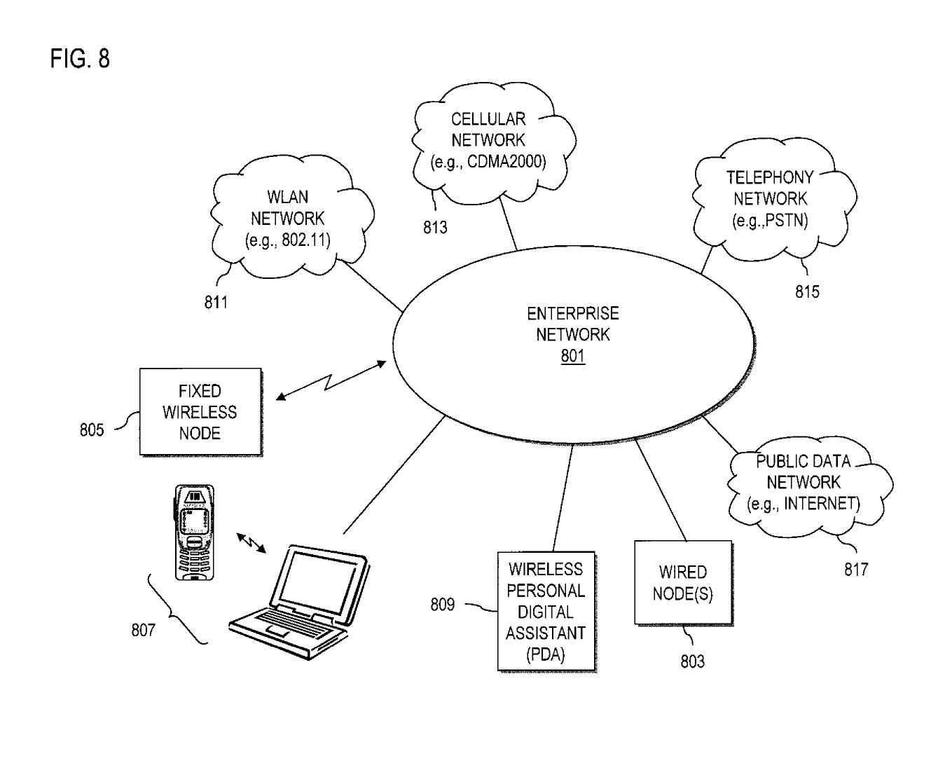

FIG. 8 shows an exemplary enterprise network, which can be any type of data communication network utilizing packet-based and/or cell-based technologies (e.g., Asynchronous Transfer Mode (ATM), Ethernet, IP-based, etc.). The enterprise network 801 provides connectivity for wired nodes 803 as well as wireless nodes 805-809 (fixed or mobile), which are each configured to perform the processes described above. The enterprise network 801 can communicate with a variety of other networks, such as a WLAN network 811 (e.g., IEEE 802.11), a cdma2000 cellular network 813, a telephony network 816 (e.g., PSTN), or a public data network 817 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request message from a computing device that is configured to execute a plurality of applications, wherein the request message specifies selection of a bearer channel and quality of service (QoS) requirement to support one of the applications; and
in response to the received request message, configuring the bearer channel with the QoS requirement, wherein the configured bearer channel is established for the one application.

2. A method according to claim 1, further comprising:
generating a configuration message to convey the configured bearer channel to a service node.

3. A method according to claim 1, wherein the request message is received according to link level protocol, and the link level protocol includes a Link Control Protocol (LCP) in Point-to-Point Protocol (PPP).

4. A method according to claim 1, wherein the QoS requirement includes a filter or tag to identify the dataflow, or QoS parameters for the dataflow.

5. A method according to claim 4, wherein negotiation of the filter or QoS parameters can occur during transmission of the dataflow.

6. A method according to claim 1, wherein the bearer channel is established over a radio link, and communication with the computing device is over a serial connection.

7. A method according to claim 1, further comprising:
renegotiating the QoS requirement with the computing device in response to the one application requiring a different QoS requirement.

8. An apparatus comprising:
a processor configured to receive a request message from a computing device that is configured to execute a plurality of applications, wherein the request message specifies selection of a bearer channel and quality of service (QoS) requirement to support one of the applications,
wherein the processor is further configured to, in response to the received request message, configure the bearer channel with the QoS requirement, wherein the configured bearer channel is established for the one application.

9. An apparatus according to claim 8, wherein the processor is further configured to generate a configuration message to convey the configured bearer channel to a service node.

10. An apparatus according to claim 8, wherein the request message is received according to link level protocol, and the link level protocol includes a Link Control Protocol (LCP) in Point-to-Point Protocol (PPP).

11. An apparatus according to claim 8, wherein the QoS requirement includes a filter or tag to identify the dataflow, or QoS parameters for the dataflow.

12. An apparatus according to claim 11, wherein negotiation of the filter or QoS parameters can occur during transmission of the dataflow.

13. An apparatus according to claim 8, wherein the bearer channel is established over a radio link, and communication with the computing device is over a serial connection.

14. An apparatus according to claim 8, wherein the processor is further configured to renegotiate the QoS requirement with the computing device in response to the one application requiring a different QoS requirement.

15. A mobile device comprising an apparatus according to claim 8, the mobile device further comprising:
means for wirelessly communicating with a radio communication network including a cellular network.

16. A method comprising:
receiving a configuration request message from a mobile terminal that is coupled to a computing device, wherein the computing device is configured to execute a plurality of applications and to specify, to the mobile terminal, selection of a bearer channel and quality of service (QoS) requirement to support one of the applications; and
generating an acknowledgement message, in response to the configuration request message, to acknowledge the selection of the bearer channel and the QoS requirement.

17. A method according to claim 16, wherein the configuration request message is received according to link level protocol, and the link level protocol includes a Link Control Protocol (LCP) in Point-to-Point Protocol (PPP).

18. A method according to claim 16, wherein the QoS requirement includes a filter or tag to identify the dataflow, or QoS parameters for the dataflow.

19. A method according to claim 18, wherein negotiation of the filter or QoS parameters can occur during transmission of the dataflow.

20. A method according to claim 16, wherein the bearer channel is established over a radio link, and communication with the computing device is over a serial connection.

21. A method according to claim 16, wherein renegotiating the QoS requirement with the computing device in response to the one application requiring a different QoS requirement.

22. An apparatus comprising:
a processor configured to receive a configuration request message from a mobile terminal that is coupled to a computing device, wherein the computing device is configured to execute a plurality of applications and to specify, to the mobile terminal, selection of a bearer channel and quality of service (QoS) requirement to support one of the applications,
wherein the processor is further configured to generate an acknowledgement message, in response to the configuration request message, to acknowledge the selection of the bearer channel and the QoS requirement.

23. An apparatus according to claim 22, wherein the configuration request message is received according to link level protocol, and the link level protocol includes a Link Control Protocol (LCP) in Point-to-Point Protocol (PPP).

24. An apparatus according to claim 22, wherein the QoS requirement includes a filter or tag to identify the dataflow, or QoS parameters for the dataflow.

25. An apparatus according to claim 24, wherein negotiation of the filter or QoS parameters can occur during transmission of the dataflow.

26. An apparatus according to claim 22, wherein the bearer channel is established over a radio link, and communication with the computing device is over a serial connection.

27. An apparatus according to claim 22, wherein renegotiating the QoS requirement with the computing device in response to the one application requiring a different QoS requirement.

28. A system comprising an apparatus according to claim 22, the system further comprising:
means for wirelessly communicating with the mobile terminal.
